(19) United States
(12) Patent Application Publication
(10) Pub. No.: US 2015/0337909 A1
(43) Pub. Date: Nov. 26, 2015

(54) VISCOUS FRICTION COUPLING

(71) Applicant: BorgWarner Inc., Auburn Hills, MI (US)

(72) Inventors: Dennis RAISER, Ravensburg (DE); Thomas BUCHHOLZ, Stockach (DE)

(21) Appl. No.: 14/410,131

(22) PCT Filed: Jun. 21, 2013
(86) PCT No.: PCT/US2013/046986

§ 371 Date: Dec. 22, 2014

(30) Foreign Application Priority Data
Jun. 26, 2012 (EP) 12004768.3

(51) Int. Cl. F16D 35/02

(52) U.S. Cl. CPC F16D 35/024

(57) ABSTRACT

The invention concerns a viscous friction coupling (1) with a housing (2, 3) with a coupling disk (4) which is rotatable in relation to the housing (2, 3) and which is arranged on one end (5) of a shaft (6) mounted centrally within the housing (2, 3), which shaft carries a drivable active element (7) on its other end (8); with a working chamber (9) between the housing (2, 3) and the coupling disk (4); with a storage chamber (10) for coupling fluid; and with a supply channel (11) which leads from the storage chamber (10) to the working chamber (9); characterized by a supply pump element (14) which is rotatable in relation to the housing (2, 3) and is integrated in the coupling disk (4).

The invention concerns a viscous friction coupling according to the preamble of claim 1.

Such a viscous friction coupling is known from DE 10 2010 043 264 A1. In this known viscous friction coupling, to separate the working chamber from the storage chamber, a separate component is provided in the form of an intermediate disk or separating wall. This separating wall is connected rigidly with the driven side i.e. the coupling housing. This separating wall has at least one valve, usually however two valves, in order to control a fluid flow between the storage chamber and the working chamber. Furthermore at least one build-up element is provided which is arranged on the gap in order to create a ram pressure in the fluid, due to the rotation speed difference, which supports the fluid flow.

However the provision of this separating wall leads to the technical problem that the installation length of the entire coupling is substantially increased. This in turn has the disadvantage that in constricted installation conditions, viscous friction couplings constructed in this way cannot be used.

The object of the present invention is to create a viscous friction coupling of the type specified in the preamble of claim 1, with which it is possible to increase the coupling efficiency and reduce the installation length of the coupling in a simple manner.

This object is achieved by the features of claim 1.

By integrating the supply pump element in the coupling disk which together with the housing defines a shear gap, it becomes possible, in a simple manner, by utilizing a differential rotation speed between the pump element and the housing or the primary side of the viscous friction coupling, to generate a volume flow from the storage chamber to the working chamber depending on the differential rotation speed.

One of the particular advantages of the viscous friction coupling according to the invention is that only a small quantity of coupling fluid is required since, because of the arrangement described above, an active delivery pump is formed in the oil reservoir which is advantageous with regard to the coupling fluid quantity in comparison with the known utilization of centrifugal forces to fill the working chamber.

Furthermore the response behavior of the viscous friction coupling according to the invention is faster because of the smaller quantity of coupling fluid.

Furthermore an extremely compact construction results since in particular the coupling length can be reduced, in that instead of a separate component to separate the working chamber and storage chamber, this separation takes place exclusively via the coupling disk, which—as well as the more compact construction—gives the advantage that the number of components can be reduced, leading to a more economic construction method.

To summarize, it can therefore be found that because of the circumstance that the supply pump element rotates with a secondary rotation speed (rotation speed of shaft or active element) and scrapes away coupling fluid from the housing, an excellent coupling performance can be achieved.

The subclaims contain further advantageous refinements of the invention.

The coupling performance can furthermore be improved in that a return pump is provided which is also integrated in the coupling disk.

Furthermore according to the invention it is possible to integrate all essential components of the coupling fluid circuit in or on the coupling disk. This applies in particular to the supply pump described above, a control valve arrangement, the labyrinth seal of the working chamber, a separating wall for separating the working chamber from the storage chamber, and the return pump, which can all be formed as integral components of the coupling disk.

Further details, advantages and features of the present invention arise from the description below of exemplary embodiments shown in the drawing. This shows:

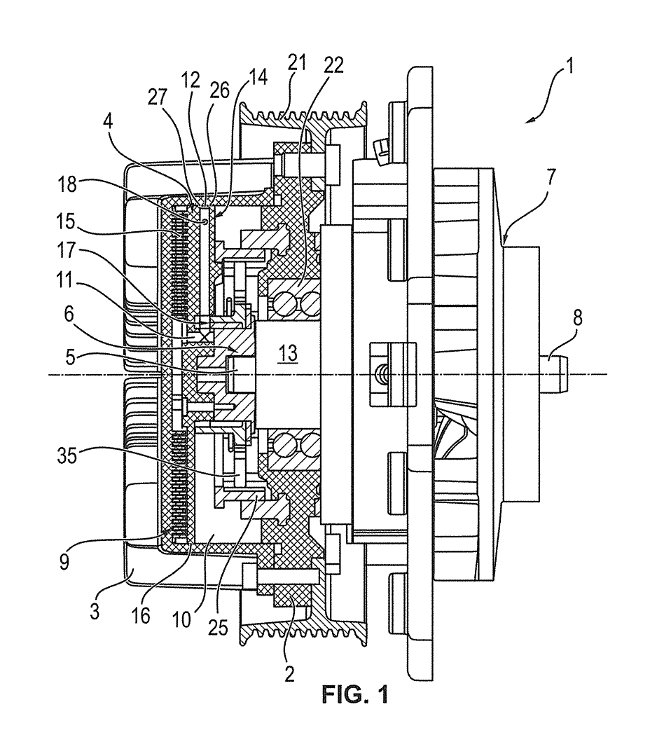

FIG. 1 a section view of a viscous friction coupling according to the invention, and

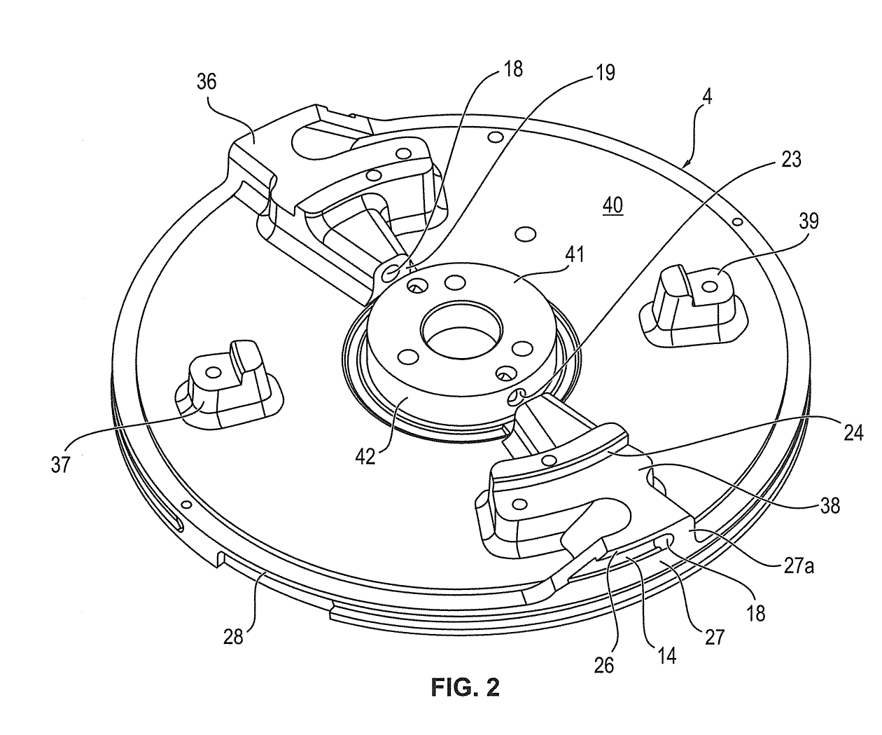

FIG. 2 a perspective view of a coupling disk of the viscous coupling according to the invention,

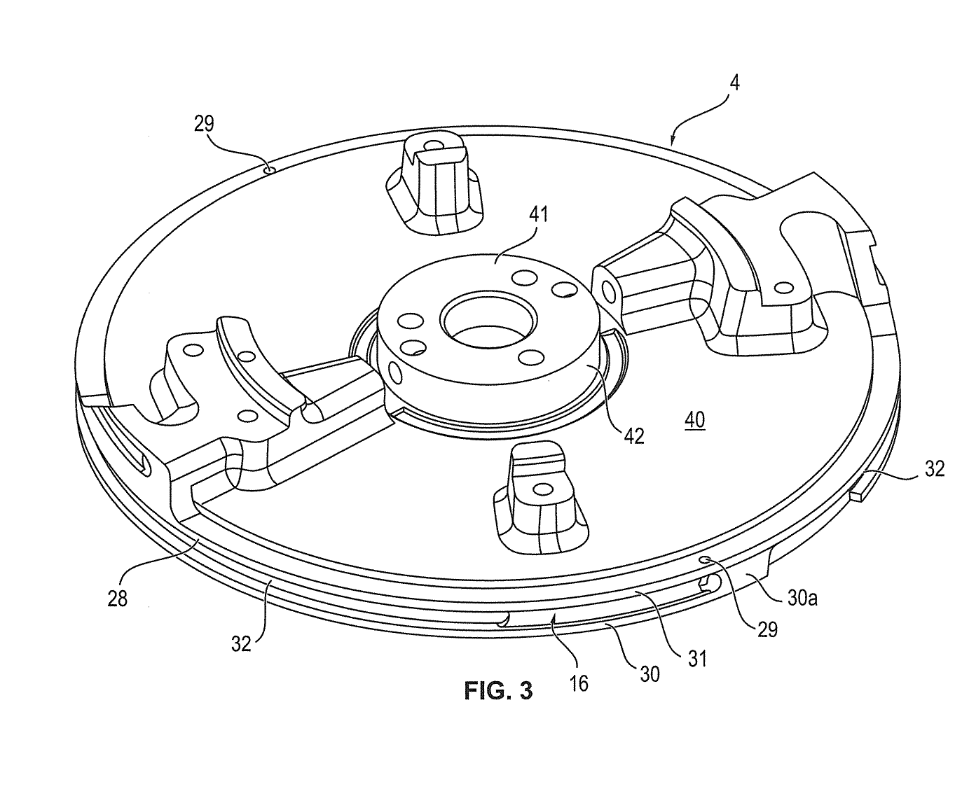

FIG. 3 a depiction corresponding to FIG. 2 of the coupling disk in rotated view, and

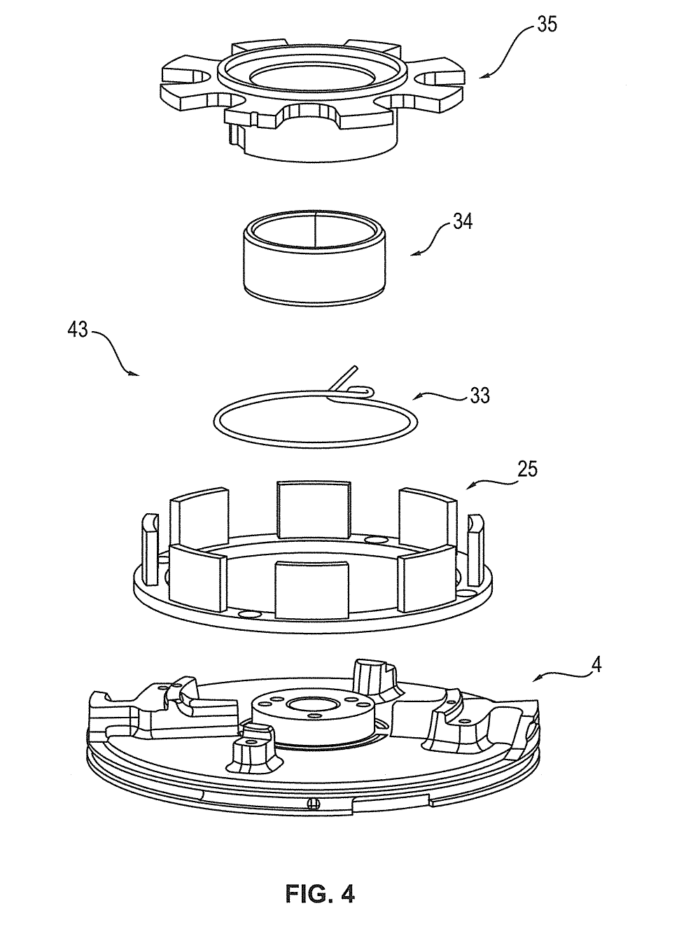

FIG. 4 an exploded view of the coupling disk and the components of a control valve arrangement.

FIG. 1 shows a section view of a viscous friction coupling 1 according to the invention which has a housing which is normally constructed from a housing body 2 and a cover 3.

A coupling disk 4 is arranged in the housing 2, 3 and is rotatable in relation to the housing 2, 3. The coupling disk 4 is here connected rotationally fixed to one end 5 of a shaft 6 mounted centrally within the housing 2, 3. At the other end 8 of the shaft, a drivable active element 7 is fixed which is shown diagrammatically for simplification and can for example be formed as an impeller or compressor.

A working chamber 9 is arranged between the housing 2, 3 and the coupling disk 4 which, as shown in FIG. 1, has working gaps 15 which enable the transmission of torque due to the shear effect on the coupling fluid supplied to the working chamber 9.

Furthermore a storage chamber 10 is provided for said coupling fluid, wherein a supply channel 11 leads from the storage chamber 10 to the working chamber 9 and thus forms the supply.

As evident in particular from FIG. 3, furthermore a return pump system or return pump 16 is provided which serves to return the coupling fluid from the working chamber 9 to the storage chamber 10. As evident from the figure, the return pump 16 is integrated in the coupling disk 4.

Furthermore a drive element 21, such as for example a belt pulley, is connected with the housing 2, 3. The viscous friction coupling 1 furthermore has a stationary coupling part 13 on which the housing 2, 3 is mounted via a main bearing 22. The shaft 6 is mounted on the stationary coupling part 13 via a secondary bearing (not shown).

As FIG. 2 shows, the viscous friction coupling 1 according to the invention is distinguished by the provision of a supply pump element 14 which is integrated in the coupling disk 4 and hence mounted rotationally fixed on the shaft 6 and thus is rotatable in relation to the housing 2, 3 but not in relation to the shaft 6.

In the examples shown, on its radial outer edge the supply pump element 14 has a shear gap 12 which is sealed against the housing 2, 3 via sealing webs 26, 27, 27a. This arrangement forms a delivery pump which, because of a differential rotation speed to be created between the supply pump element 14 and the housing 2, 3, allows a volume flow of coupling fluid from the storage chamber 10 to the working chamber 9.

The volume flow from the storage chamber 10 to the working chamber 9 is produced by the abovementioned supply pump element 14 in connection with said shear gap 12. The supply pump element 14 and the shear gap 12 here form a delivery pump, the active principle of which is based on a differential rotation speed.

As FIG. 1 furthermore shows, a valve 17 is arranged in the supply channel 11 and regulates the supply to the working chamber 9 together with the supply pump element 14 rotating with the secondary rotation speed.

FIG. 2 shows the coupling disk 4 in a view onto a back face 40 of the coupling disk 4, which is the face lying opposite the face with the working gaps 15.

In the particularly preferred embodiment shown in FIG. 2, the guide pieces 36 and 38 each have a filling channel 18, wherein the filling channel of guide piece 36 is not visible because of the view selected in FIG. 2. The opening visible on the guide piece 36 constitutes the end of the channel 18 which is arranged on the guide piece 38. The filling channel 18 opens into the supply pump element 14 which can be seen on the guide piece 38. The supply pump element 14 is delimited by webs 26, 27 and 27a. In the particularly preferred embodiment shown in FIG. 2, the structure is symmetrical and the guide pieces 36 and 38 each have a filling channel 18 and a supply pump element 14. However an asymmetrical arrangement would also be conceivable as an alternative, wherein then only one of the guide pieces 36 or 38 with the respective filling channel 18 and supply pump element 14 is provided.

As FIG. 2 also shows, the guide piece 36 has a sealing face 19 for the valve 17.

A further sealing face 23 can be seen in FIG. 2, which is provided in a cylinder wall 42 of a central guide cylinder 41.

Finally FIG. 2 shows the provision of a separating web 28, also shown in FIG. 3, which forms an integral part of the coupling disk 4. The separating web 28 serves to separate the storage chamber 10 from the working chamber 9 without a further separate component being required for this.

The view of the coupling disk 4 in FIG. 3 furthermore shows that the return pump 16 is also an integral part of the coupling disk 4, wherein the return pump 16 is delimited by three sealing webs 30, 30a and 31 and leads into a return bore 29. Also, the particularly preferred embodiment shown in FIG. 3 is formed so as to be symmetrical with regard to the return pump 16, which means that two return pumps 16 are provided, wherein the second return pump (not shown in FIG. 3) is arranged on the face wall region of the coupling disk 4 diametrically opposite the return pump 16. With regard to its construction, this second return pump corresponds to the return pump 16 shown in FIG. 3.

Furthermore, as well as the return pump 16, a collection channel 32 is provided in the circular peripheral end face of the coupling disk 4 in order to collect the returning flow of oil or coupling fluid. With regard to the collection channel 32, it should be emphasized that this too is a symmetrical construction which, corresponding to the particularly preferred embodiment in FIG. 3, has two collection channels of which only the collection channel shown in FIG. 3 is visible. The second collection channel 32 is again arranged diametrically opposite the collection channel shown in FIG. 3 and is constructed identically.

As emphasized in connection with the feature of the filling channel and the supply pump element, also with regard to the return pump 16 and the collection channel 32 an asymmetric configuration is conceivable in which only one return pump and one collection channel are provided.

FIG. 4 finally shows an exploded view of a control valve arrangement, designated as a whole with reference numeral 43, and the coupling disk 4, which are shown in mounted state in FIG. 1.

The control valve arrangement 43 has a flux ring 25, a reset spring 33, a bush 34 and an armature 35 with valve function, the construction of which is shown in detail in the view in FIG. 4, to which explicit reference is made in this context.

In the final mounted state shown in FIG. 1, the control valve arrangement 43 also forms an integral part of the coupling disk 4, further supporting the compact construction of the viscous friction coupling 1 according to the invention.

To summarize, it can also be found that the principles according to the invention allow an integration of the supply pump element or filling pump 14 on the coupling disk 4, wherein the supply pump element 14 allows a fluid flow from the storage chamber 10 to the working chamber 9 and hence into the coupling disk 4.

Furthermore the integration of the return pump 16, which causes a return flow of coupling fluid from the working chamber 9 to the storage chamber 10, in the coupling disk 4 can also be made possible.

The pump systems described use sealing walls or sealing webs between the coupling disk 4 and the housing 2, 3 of the viscous friction coupling 1.

Furthermore the pump systems described are parts which rotate in relation to the housing 2, 3 and thus build up a pressure which depends on a rotation speed difference between the housing 2, 3 and the coupling disk 4.

The control valve arrangement 43 described in FIG. 4 can also be integrated in or arranged on the coupling disk 4 as a whole component.

Finally a separating wall or separating web 28 is provided as an integral part of the coupling disk 4, causing the separation between the working chamber 9 and storage chamber 10 without an additional part being required for this separation. This separating wall or separating web delimits a rotating gap between the housing 2, 3 and the coupling disk 4, giving the advantage of a minimum leakage rate.

As well as the written disclosure of the invention, explicit reference is hereby made to the drawing depiction in FIGS. 1 to 4.

### LIST OF REFERENCE NUMERALS

1 Viscous friction coupling
2, 3 Housing (2: housing body, 3: cover)
4 Coupling disk

5 End of shaft 6
6 Shaft
7 Active element (e.g. impeller, fan wheel etc.)
8 Second end of shaft 6
9 Working chamber
10 Storage chamber
11 Supply channel
12 Shear gap
13 Stationary coupling part (pump housing)
14 Supply pump element
15 Working gap
16 Return pump/discharge pump system
17 Valve
18 Filling channel
19 First sealing face of valve (outer sealing face)
21 Drive element, in particular belt pulley on housing 2, 3
22 Main bearing
23 Second sealing face of valve (inner sealing face)
24 Centering of flux ring
25 Flux ring
26, 27, 27a Sealing webs
28 Separating web/separating wall
29 Return bore
30, 30a, 31 Sealing webs
32 Collection channel
33 Reset spring
34 Bush
35 Armature with valve function
36 to 39 Guide pieces
40 Back face
41 Central guide cylinder
42 Cylinder wall
43 Control valve arrangement

In the claims:

1. A viscous friction coupling (1),
with a housing (2, 3)
with a coupling disk (4),
which is rotatable in relation to the housing (2, 3) and
which is arranged on one end (5) of a shaft (6) mounted centrally within the housing (2, 3), which shaft carries a drivable active element (7) on its other end (8);
with a working chamber (9) between the housing (2, 3) and the coupling disk (4);
with a storage chamber (10) for coupling fluid; and
with a supply channel (11) which leads from the storage chamber (10) to the working chamber (9);
characterized by a supply pump element (14) which is rotatable in relation to the housing (2, 3) and is integrated in the coupling disk (4).

2. The viscous friction coupling as claimed in claim 1, characterized in that the coupling disk (4) is arranged rotationally fixed on the shaft (6).

3. The viscous friction coupling as claimed in claim 1, characterized in that the coupling disk (4) with the supply pump element (14) defines a shear gap (12) with the housing (2, 3).

4. The viscous friction coupling as claimed in claim 1, characterized in that a valve (17) is arranged in the supply channel (11).

5. The viscous friction coupling as claimed in claim 1, characterized by a return pump (16) for returning coupling fluid from the working chamber (9) to the storage chamber (10).

6. The viscous friction coupling as claimed in claim 5, characterized in that the return pump (16) is integrated in the coupling disk (4).

7. The viscous friction coupling as claimed in claim 1, characterized in that the working chamber (9) is separated from the storage chamber (10) by the coupling disk (4).

8. The viscous friction coupling as claimed in claim 7, characterized in that the coupling disk (4) has at least one separating web (28).

9. The viscous friction coupling as claimed in claim 1, characterized in that a control valve arrangement (43) is provided which is arranged on the coupling disk (4).

10. The viscous friction coupling as claimed in claim 1, characterized by a stationary coupling part (13), in relation to which the housing (2, 3) is rotatable.

11. The viscous friction coupling as claimed in claim 3, characterized in that the shear gap (12) is delimited by three side walls.
